(19) United States
(12) Patent Application Publication
(10) Pub. No.: US 2025/0114963 A1
(43) Pub. Date: Apr. 10, 2025

(54) Nail Driving Assembly and Loose Nail Driving Device for Wooden Pallets

(71) Applicants: Xiaorong Li, Taizhou (CN); Xiaopeng Li, Taizhou (CN); Qin Li, Taizhou (CN)

(72) Inventors: Xiaorong Li, Taizhou (CN); Xiaopeng Li, Taizhou (CN); Qin Li, Taizhou (CN)

(21) Appl. No.: 18/784,861

(22) Filed: Jul. 25, 2024

(30) Foreign Application Priority Data
Oct. 7, 2023 (CN) 202322663037.X
Oct. 25, 2023 (CN) 202311390939.9

(51) Int. Cl. B27F 7/13; B27F 7/09

(52) U.S. Cl. CPC B27F 7/13; B27F 7/09

(57) ABSTRACT

A loose nail driving device for wooden pallets, comprising a crossbeam, with its lower part allowing semi-finished pallets to pass through, multiple support slides arranged on the crossbeam, which can slide to achieve position adjustment in the transverse direction of the crossbeam. A nailing unit is arranged on the support slides, used for nailing operations at various foot block positions of the semi-finished pallets. The nailing unit includes a frame and a nail driving assembly arranged on the frame. The frame is connected to the support slides through a lifting cylinder. A rotatable large gear and a driving mechanism for driving the large gear are configured on the base frame of the frame. An eccentric hole is machined on the disk surface of the large gear, and the lower end of the nail head of the nail driving assembly is configured within the eccentric hole through a first bearing.

### FIELD OF THE INVENTION

The present invention relates to a nail driving assembly and a loose nail driving device for wooden pallets.

### BACKGROUND OF THE INVENTION

After stacking wooden flat plates and foot blocks to form a semi-finished pallet, a nailing machine drives nails into the foot blocks to form a fixed structure between the flat plates and foot blocks, thereby creating the desired wooden pallet. Typically, two or three nails are driven into a single foot block on a wooden pallet, as shown in FIG. 9 for two nails and FIG. 10 for three nails.

A handheld nailing machine can drive multiple nails into the foot blocks, with the nail positions determined manually by the operator, which results in high labor intensity and low work efficiency. Existing production workshops also have automatic nailing equipment for wooden pallets. By pushing the semi-finished pallet placed on the push rack under the nailing equipment, nailing can be achieved. When it comes to nails in different positions on a single foot block, current equipment relies on the longitudinal movement of the push rack combined with the transverse movement of the nailing assembly to adjust the nail positions. This adjustment process is time-consuming and limits the overall efficiency of the automatic nailing equipment.

### SUMMARY OF THE INVENTION

To address the deficiencies mentioned above, the present invention provides a nail driving assembly and a loose nail driving device for wooden pallets.

To achieve the above purpose, on one hand, the present invention provides a nail driving assembly, which includes a nail guide disk housing, a nail guide disk, a ratchet, a ratchet positioning mechanism, a push rod piston mechanism, and a nail guide tube. The nail guide disk is rotatably arranged within the nail guide disk housing through a second bearing. Multiple nail slots for accommodating nails are evenly arranged on the circumferential surface of the nail guide disk. The ratchet is fixedly connected to the nail guide disk via bolts and rotates synchronously with the nail guide disk. The ratchet positioning mechanism is arranged on one side of the ratchet to allow the ratchet to rotate unidirectionally. The push rod piston mechanism is arranged on the other side of the ratchet to drive the ratchet to rotate stepwise by a set angle. The nail guide tube is vertically fixed to the nail guide disk housing, with the feed channel of the nail guide tube aligned with one of the nail slots on the nail guide disk to allow nails to fall from the nail guide tube into the nail slot. A nail head is fixed to the nail guide disk housing, with a through-hole machined in the middle of the nail head. A magnet is arranged inside the nail head, located on one side of the through-hole, and uses magnetic force to attract the nail in the adjacent nail slot to the through-hole. A reciprocating striker moves along the axial direction of the through-hole to shoot the nail out of the through-hole, completing the nailing action.

Further, the ratchet positioning mechanism includes a positioning sleeve fixed to the nail guide disk housing, a positioning pin inside the positioning sleeve, and a first spring supporting the positioning pin. The positioning pin interacts with the ratchet teeth through an inclined surface on the left side, allowing the ratchet to rotate only in the counterclockwise direction.

Further, the push rod piston mechanism includes a solenoid valve, a cylinder, and a push rod assembly. The cylinder is fixed to the nail guide disk housing, with the cylinder shaft arranged along the tangential direction of the ratchet. The push rod assembly is fixed to the shaft end of the cylinder, and the solenoid valve is fixed to the nail guide disk housing. The solenoid valve controls the reciprocating motion of the push rod assembly by reversing the airflow direction in the cylinder.

Further, the push rod assembly includes a push rod sleeve fixed to the cylinder shaft, a push rod inside the push rod sleeve, and a second spring supporting the push rod. The push rod interacts with the ratchet teeth through an inclined surface on the right side, driving the ratchet to rotate stepwise by a set angle in the counterclockwise direction.

Further, a first opening slot is formed on the nail guide disk housing, and a second opening slot is formed on the nail head. The first opening slot communicates with the second opening slot to facilitate the transfer of nails from the nail slot to the through-hole.

On the other hand, the present invention provides a loose nail driving device for wooden pallets, which includes:

A crossbeam, with the lower part allowing the semi-finished pallet to pass through. The crossbeam is equipped with multiple support slides, which can slide to achieve position adjustment in the transverse direction of the crossbeam;

A nailing unit, which is arranged on the support slides and used for nailing operations at various foot block positions of the semi-finished pallet;

The nailing unit includes a frame and a nail driving assembly arranged on the frame. The frame is connected to the support slides through a lifting cylinder. A rotatable large gear and a driving mechanism for driving the large gear are disposed on the base frame of the frame. An eccentric hole is machined on the disk surface of the large gear, and the nail head of the nail driving assembly is disposed within the eccentric hole through a first bearing.

To ensure the overall stability of the nail driving assembly, multiple universal wheel assemblies are mounted on the nail driving assembly, with the balls at the bottom of the universal wheel assemblies sliding in contact with the upper surface of the large gear. A connecting rod frame is fixed to the top of the nail driving assembly. A guide block is fixed to the upper part of the side frame of the frame. A rotatable connecting rod is arranged on the connecting rod frame, with the outer end of the connecting rod extending into the guide hole of the guide block.

Further, the large gear forms a rotatable structure with the base frame through a large bearing. Multiple steel balls distributed circumferentially are arranged between the large gear and the base frame, forming a plane bearing structure between them.

Further, the driving mechanism includes a driving motor, a driving gear arranged on the output end of the driving motor, and an intermediate gear for transmitting the connection between the driving gear and the large gear.

The beneficial effects of the present invention compared to the prior art are: The nail head of the nail driving assembly is eccentrically mounted in the eccentric hole of the large gear. The nail driving assembly, large gear, connecting rod, and guide block together form a crank-slider mechanism. During nailing, the rotation angle of the large gear can be controlled by the driving motor, quickly achieving nail head position adjustment. The nailing efficiency is significantly improved. The device structure design is compact and reasonable. Multiple loose nails can be driven into a foot block of the wooden pallet, with the nails arranged in a circular distribution.

### BRIEF DESCRIPTION OF THE DRAWINGS

FIG. 1 is a perspective view of the loose nail driving device for wooden pallets involved in this invention;

FIG. 2 is a schematic diagram of the crossbeam involved in this scheme;

FIG. 3 is a schematic diagram of the support slide and nailing unit involved in this scheme;

FIG. 4 is an exploded view of the nailing unit in FIG. 3;

FIG. 5 is an exploded view of the frame part in FIG. 4;

FIG. 6 is an exploded view of the nail driving assembly part in FIG. 4;

FIG. 7 is a sectional view of the nailing unit involved;

FIG. 8 is a schematic diagram of the transmission structure of the drive assembly and the large gear involved;

FIG. 9 is a schematic diagram of a wooden pallet with two nails;

FIG. 10 is a schematic diagram of a wooden pallet with three nails;

FIG. 11 is a structural diagram of the nail driving assembly part involved;

FIG. 12 is an exploded view of the part in FIG. 11;

FIG. 13 is a sectional view of the part in FIG. 11;

FIG. 14 is a structural diagram of the ratchet positioning mechanism and push rod piston mechanism;

FIG. 15 is a schematic diagram of the nail guide disk driving nails to rotate.

### DETAILED DESCRIPTION OF THE EMBODIMENTS

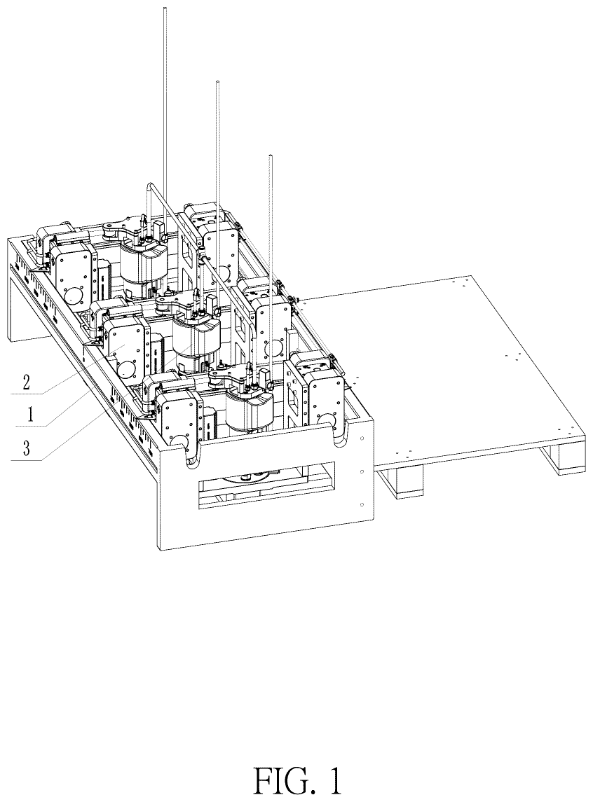

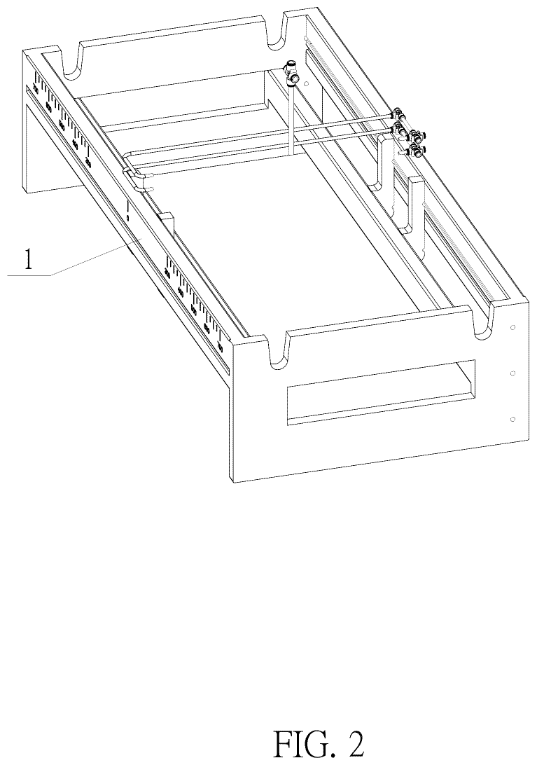

As shown in FIGS. 1, 2, and 3, a loose nail driving device for wooden pallets according to an embodiment of the present invention includes a crossbeam 1, with its lower part allowing semi-finished pallets to pass through. Three support slides 2 are arranged on the crossbeam 1, and the support slides 2 can slide to adjust their positions in the transverse direction of the crossbeam 1.

After adjusting the positions of the support slides 2, they can be locked to fix the positions. In this way, the three support slides 2 can be adjusted to suit nailing operations for wooden pallets of different widths. Each support slide 2 is equipped with a nailing unit 3, which is used for nailing operations at various foot block positions of the semi-finished pallets.

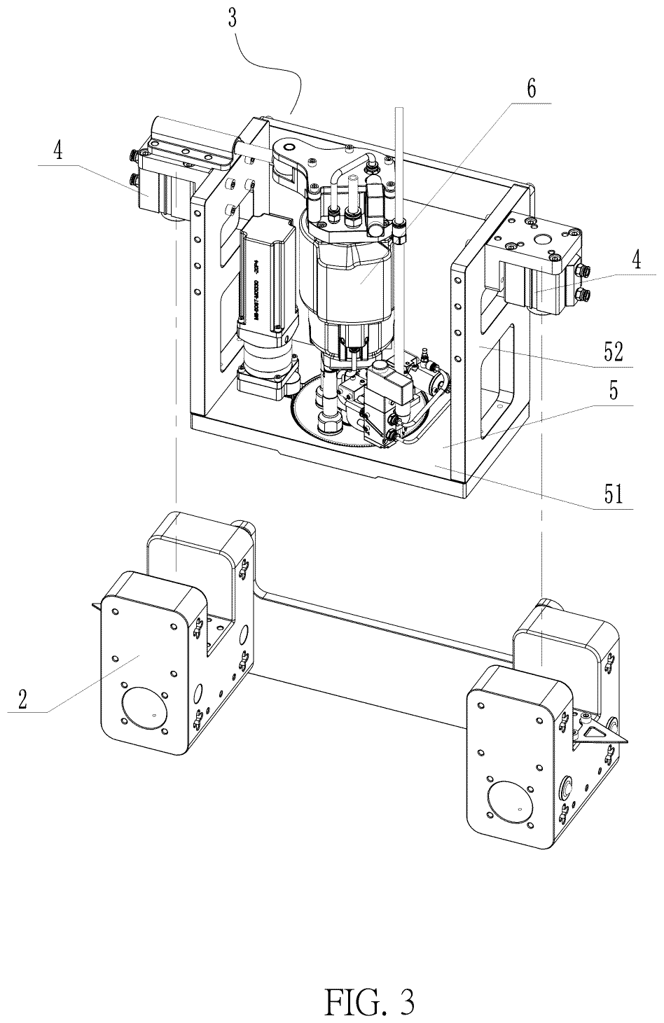

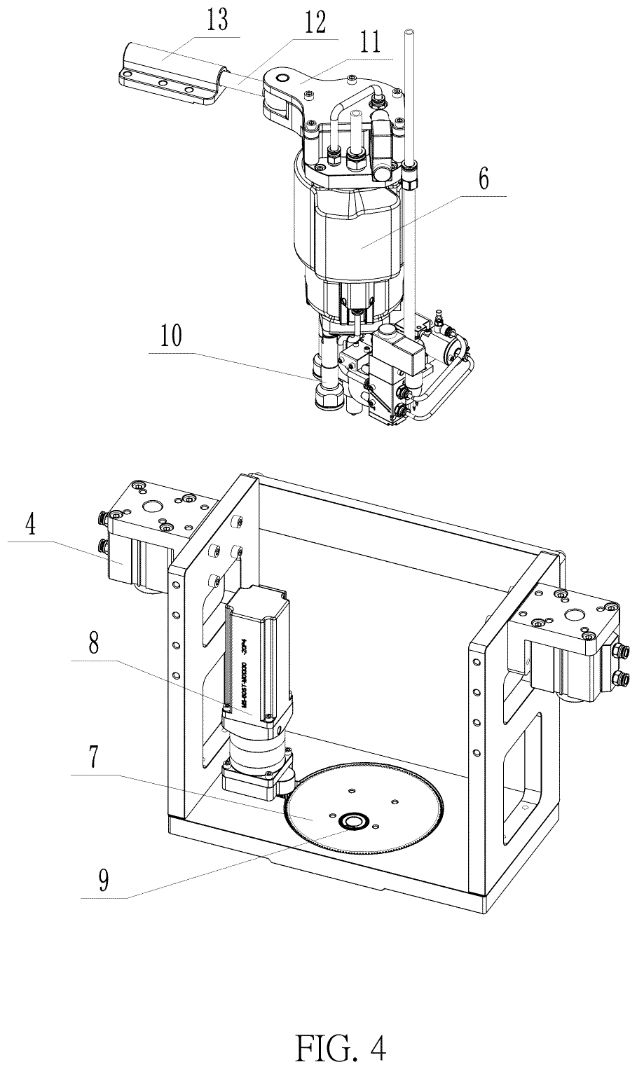

As shown in FIGS. 3 to 5, the nailing unit 3 includes a frame 5 and a nail driving assembly 6 arranged on the frame 5. The frame 5 is connected to the support slide 2 through a lifting cylinder 4. A rotatable large gear 7 and a driving mechanism 8 for driving the large gear 7 are disposed on the base frame 51 of the frame 5. An eccentric hole 71 is machined on the disk surface of the large gear 7, and the lower end of the nail head 61 of the nail driving assembly 6 is disposed within the eccentric hole 71 through a first bearing 9.

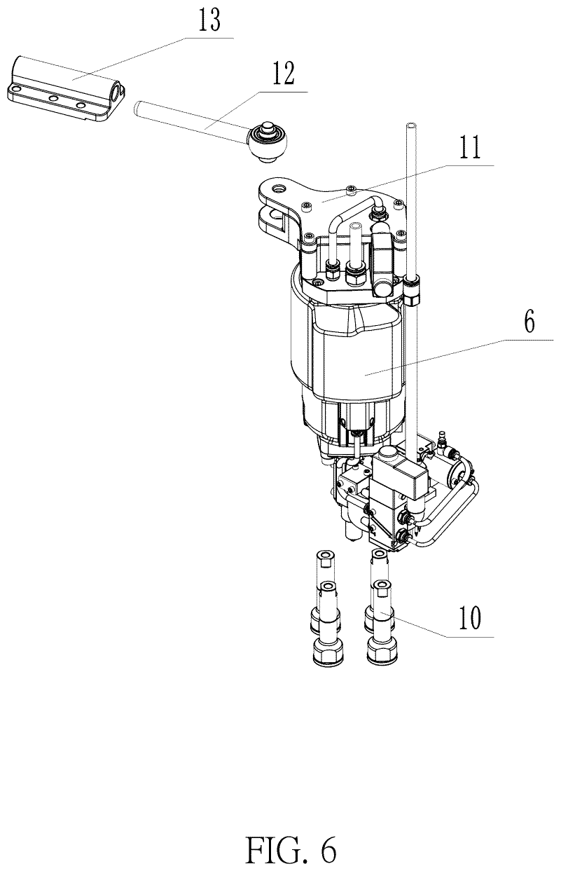

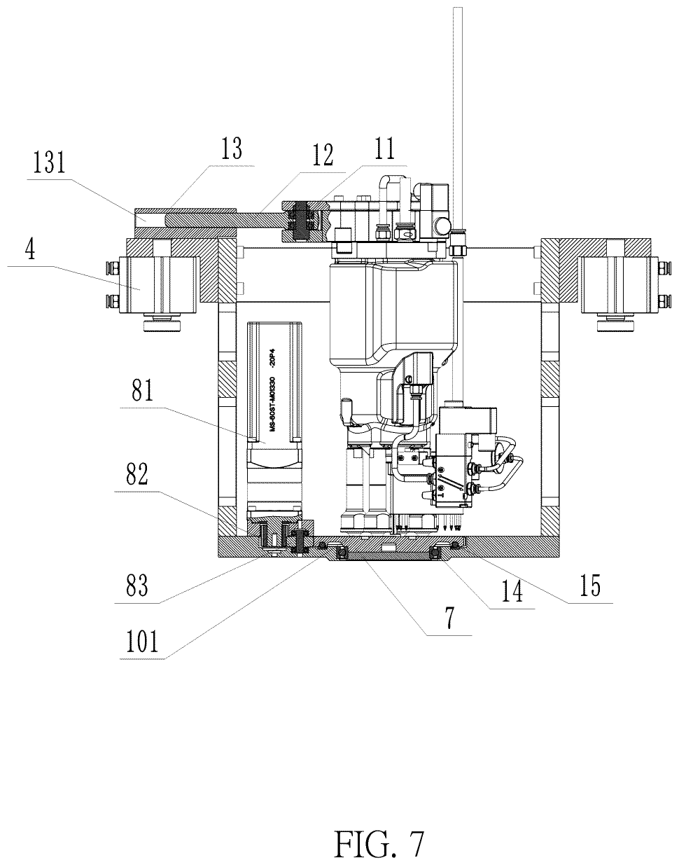

As shown in FIGS. 6 and 7, when the large gear 7 rotates, to ensure the overall stability of the nail driving assembly 6, four universal wheel assemblies 10 are installed on the nail driving assembly 6. The balls 101 at the bottom of the universal wheel assemblies 10 slide in contact with the upper surface of the large gear 7. A connecting rod frame 11 is fixed to the top of the nail driving assembly 6. A guide block 13 is fixed to the upper part of the side frame 52 of the frame 5. A rotatable connecting rod 12 is arranged on the connecting rod frame 11, with the outer end of the connecting rod 12 extending into the guide hole 131 of the guide block 13.

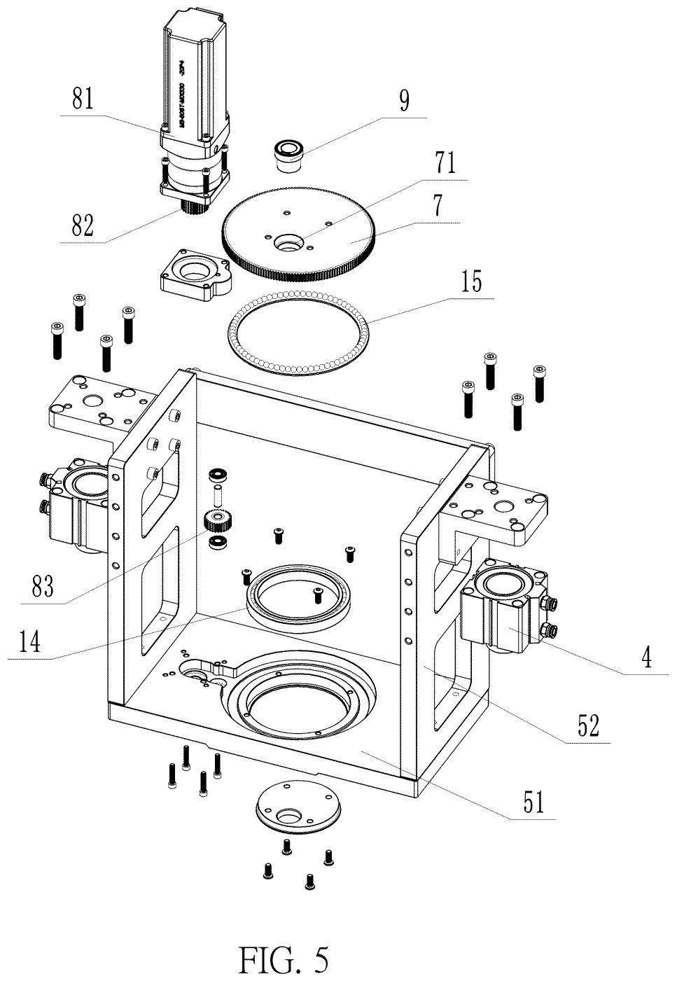

As shown in FIGS. 5 and 7, to ensure the stability of the rotation of the large gear 7, the large gear 7 forms a rotatable structure with the base frame 51 through a large bearing 14. Multiple steel balls 15 distributed circumferentially are arranged between the large gear 7 and the base frame 51, forming a plane bearing structure between them.

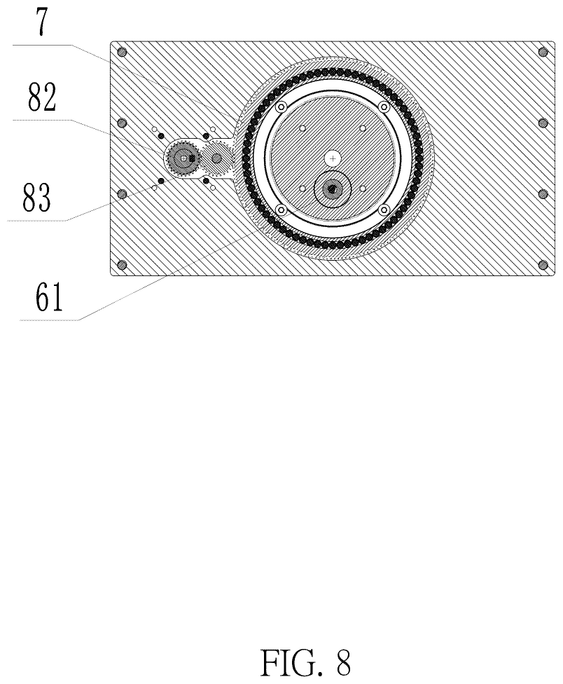

As shown in FIGS. 7 and 8, the driving mechanism 8 includes a driving motor 81, a driving gear 82 arranged on the output end of the driving motor 81, and an intermediate gear 83 for transmitting the connection between the driving gear 82 and the large gear 7.

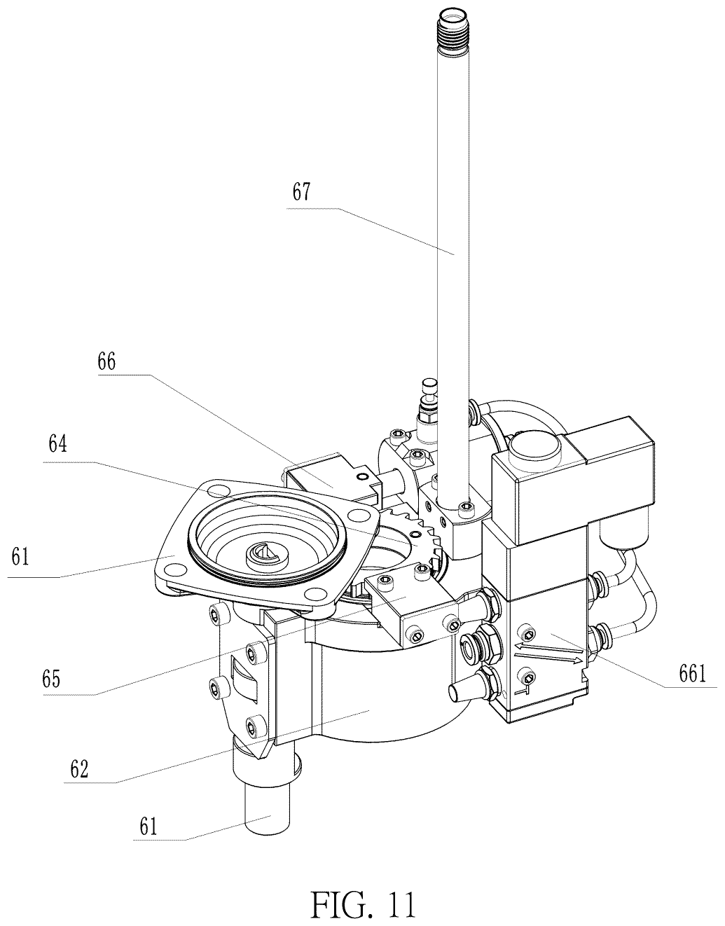

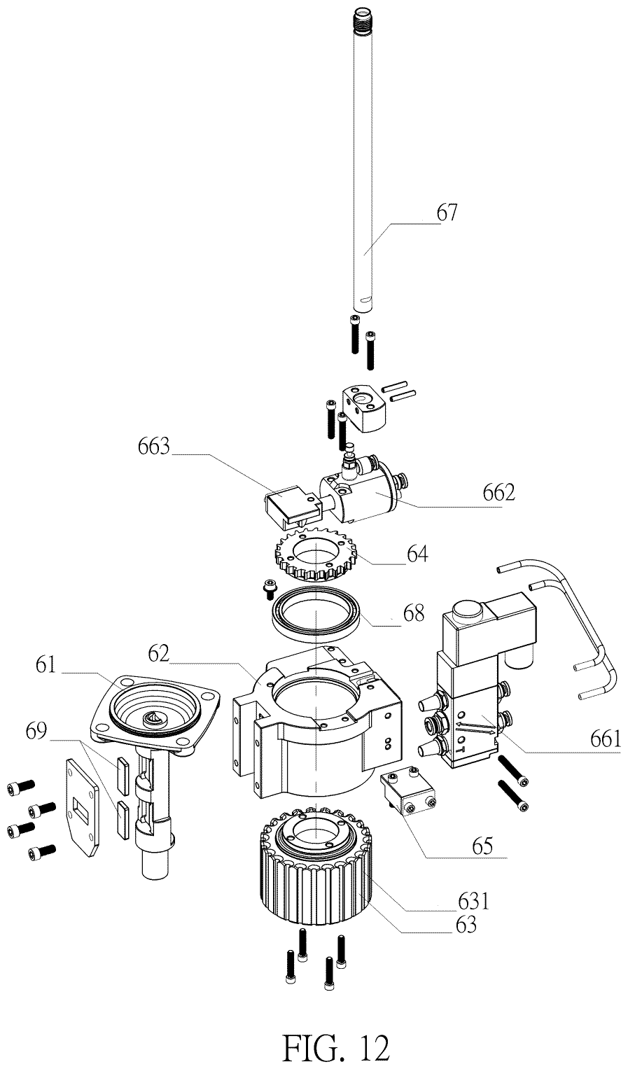

As shown in FIGS. 11 to 13, the nail driving assembly 6 also includes a nail guide disk housing 62, a nail guide disk 63, a ratchet 64, a ratchet positioning mechanism 65, a push rod piston mechanism 66, and a nail guide tube 67. The nail guide disk 63 is rotatably arranged within the nail guide disk housing 62 through a second bearing 68. Twenty-four nail slots 631 for accommodating nails 16 are evenly arranged on the circumferential surface of the nail guide disk 63. The ratchet 64 is fixedly connected to the nail guide disk 63 via bolts and rotates synchronously with the nail guide disk 63. The ratchet positioning mechanism 65 is arranged on one side of the ratchet 64 to allow the ratchet 64 to rotate unidirectionally. The push rod piston mechanism 66 is arranged on the other side of the ratchet 64 to drive the ratchet 64 to rotate stepwise by a set angle. The nail guide tube 67 is vertically fixed to the nail guide disk housing 62, with the feed channel of the nail guide tube 67 aligned with one of the nail slots 631 on the nail guide disk 63 to allow nails 16 to fall from the nail guide tube 67 into the nail slot 631. A nail head 61 is fixed to the nail guide disk housing 62, with a through-hole 611 machined in the middle of the nail head 61. A magnet 69 is arranged inside the nail head 61, located on one side of the through-hole 611, and uses magnetic force to attract the nail 16 in the adjacent nail slot 631 to the through-hole 611. A reciprocating striker moves along the axial direction of the through-hole 611 to shoot the nail 16 out of the through-hole 611, completing the nailing action.

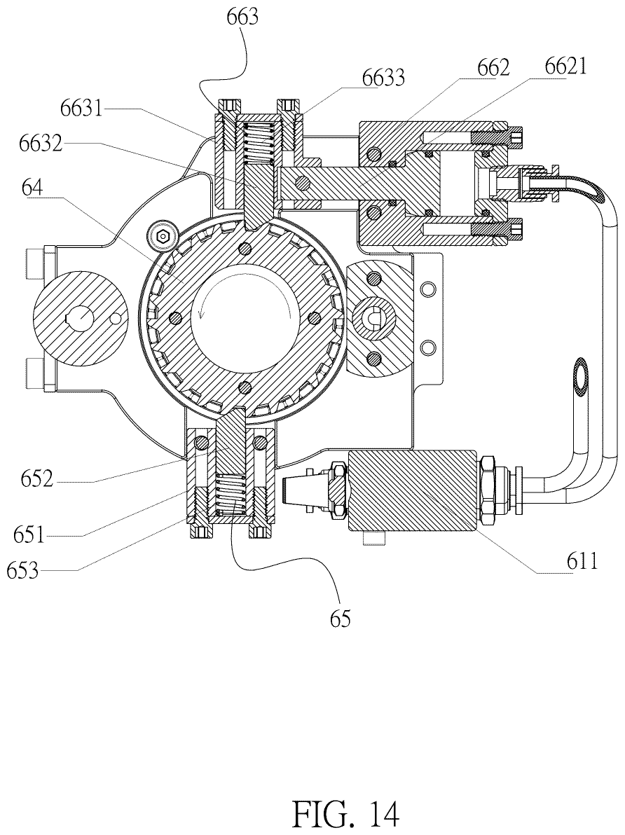

As shown in FIG. 14, the ratchet positioning mechanism 65 includes a positioning sleeve 651 fixed to the nail guide disk housing 62, a positioning pin 652 inside the positioning sleeve 651, and a first spring 653 supporting the positioning pin 652. The positioning pin 652 interacts with the ratchet teeth through an inclined surface on the left side, allowing the ratchet 64 to rotate only in the counterclockwise direction. The push rod piston mechanism 66 includes a solenoid valve 661, a cylinder 662, and a push rod assembly 663. The cylinder 662 is fixed to the nail guide disk housing 62, with the cylinder shaft 6621 arranged along the tangential direction of the ratchet 64. The push rod assembly 663 is fixed to the shaft end of the cylinder 662, and the solenoid valve 661 is fixed to the nail guide disk housing 62. The solenoid valve 661 controls the reciprocating motion of the push rod assembly 663 by reversing the airflow direction in the cylinder 662. The push rod assembly 663 includes a push rod sleeve 6631 fixed to the cylinder shaft, a push rod 6632 inside the push rod sleeve 6631, and a second spring 6633 supporting the push rod 6632. The push rod 6632 interacts with the ratchet teeth through an inclined surface on the right side, driving the ratchet 64 to rotate stepwise by a set angle in the counterclockwise direction.

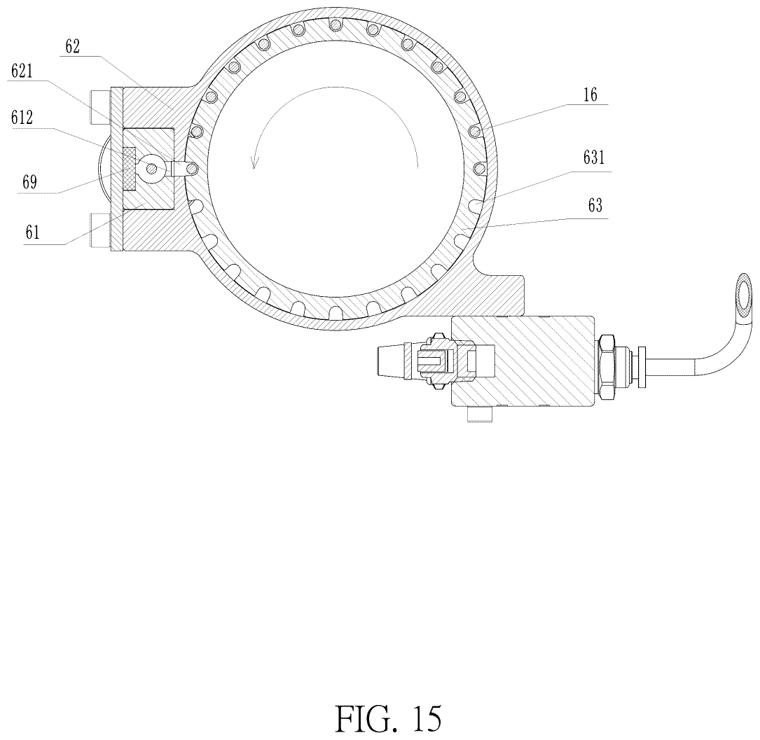

As shown in FIG. 15, a first opening slot 621 is formed on the nail guide disk housing 62, and a second opening slot 612 is formed on the nail head 61. The first opening slot 621 communicates with the second opening slot 612 to facilitate the transfer of nails 16 from the nail slot 631 to the through-hole 611.

The nail head of the nail driving assembly is eccentrically mounted in the eccentric hole of the large gear. The nail driving assembly, large gear, connecting rod, and guide block together form a crank-slider mechanism. During nailing, the rotation angle of the large gear can be controlled by the driving motor, quickly achieving nail head position adjustment. The nailing efficiency is significantly improved. The device structure design is compact and reasonable. Multiple loose nails can be driven into a foot block of the wooden pallet, with the nails arranged in a circular distribution.

In specific use, for easy understanding of the present invention, it is described in conjunction with the attached drawings.

The rotation of the nail guide disk 63 is as follows: the rotation of the nail guide disk 63 is consistent with the rotation of the ratchet 64. As shown in FIG. 14, the first spring 653 keeps the positioning pin 652 continuously pressed against the ratchet 64. The left side of the positioning pin 652 has an inclined surface, allowing the ratchet 64 to rotate counterclockwise (the positioning pin 652 retracts by overcoming the elastic force of the first spring 653). The clockwise rotation of the ratchet 64 is restricted. The solenoid valve 661 reverses to cause the cylinder shaft 6621 to reciprocate, enabling the push rod assembly 663 to move synchronously back and forth. During leftward movement, the push rod 6632 forces the ratchet 64 to rotate counterclockwise by a set angle (15 degrees). During rightward movement, the right side of the push rod 6632 has an inclined surface, allowing the push rod 6632 to retract by overcoming the elastic force of the second spring 6633. During rightward movement, the ratchet 64 does not rotate. This way, during one expansion and contraction movement of the cylinder 662, the nail guide disk 63 rotates counterclockwise by a set angle, transferring the position of the nail 16.

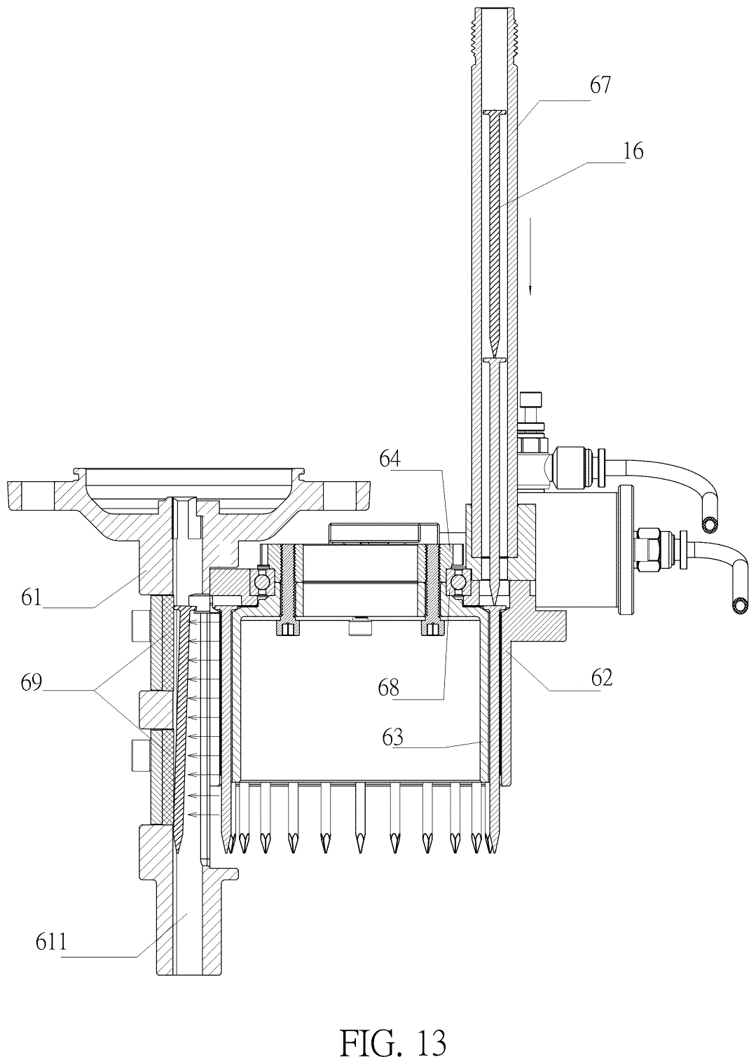

The upper end of the nail guide tube 67 is connected to a vibrating plate via a hose. The vibrating plate sequentially supplies individual nails 16 (with the pointed part facing down). The nails 16 sequentially fall into the corresponding nail slots 631 and are transferred by the rotation of the nail guide disk 63. When the nail 16 rotates to the position of the first opening slot 621, the magnet 69 attracts the nail 16 and transfers it to the through-hole 611 of the nail head 61 through the first opening slot 621 and the second opening slot 612 (as shown in FIG. 15). The situation when the nail 16 is attracted is shown in FIG. 13. After that, the nailing machine mounted on the upper part of the nail head 61 drives the striker to move downward to strike out the attracted nail 16, completing the nailing action. The nailing machine is a conventional pneumatic nailing machine, which will not be described in detail here.

The lifting cylinder 4 can lift the nailing unit 3 to allow the semi-finished wooden pallet to pass through below. When the foot block of the semi-finished wooden pallet reaches the position directly below the nail head 61, the lifting cylinder 4 lowers the nailing unit 3 to perform the nailing operation.

During the rotation of the large gear 7, as the nail head 61 is eccentrically arranged in the eccentric hole 71, the position of the nail head 61 changes with the rotation of the large gear 7, i.e., the position of the nailing is adjusted. During the rotation, the balls 101 at the bottom of the universal wheel assemblies 10 slide in contact with the upper surface of the large gear 7. Above the nail driving assembly 6, the connecting rod 12 performs telescopic movement in the guide hole 131 of the guide block 13. This way, the overall angle of the nail driving assembly 6 is adjusted in real-time, ensuring the stability of the nail driving assembly 6.

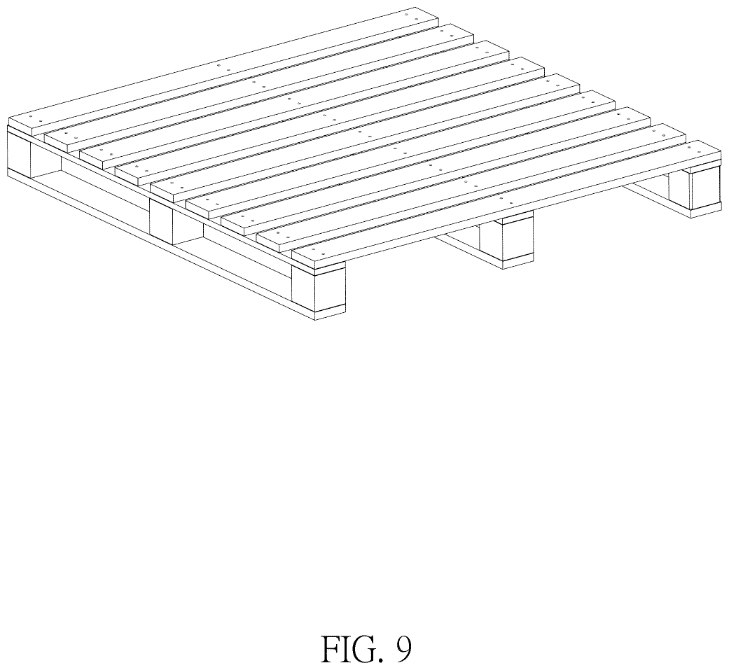

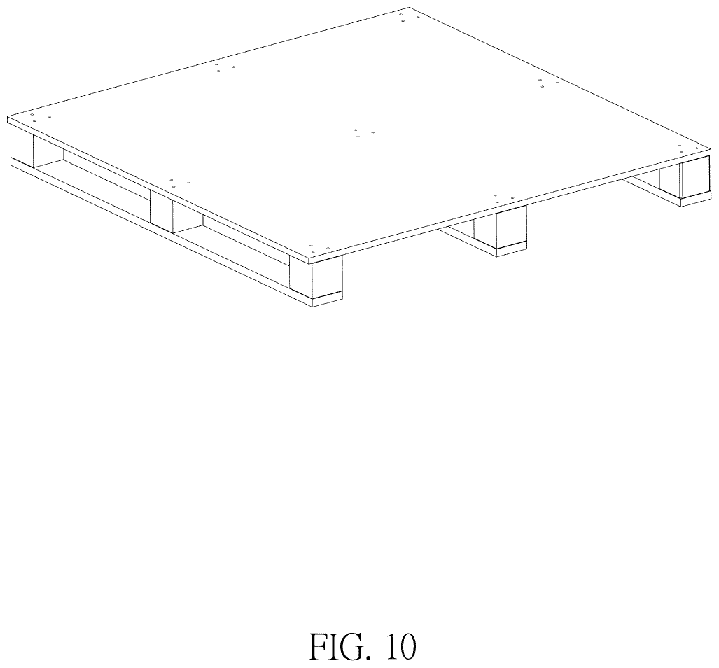

When processing the wooden pallet shown in FIG. 9, the driving motor 81 controls the large gear 7 to rotate 180 degrees once, nailing in two positions. When processing the wooden pallet shown in FIG. 10, the driving motor 81 controls the large gear 7 to rotate 120 degrees twice, nailing in three positions.

The above descriptions are merely preferred embodiments of the present invention and are not intended to limit the invention. Various modifications and changes can be made by those skilled in the art without departing from the spirit and principles of the invention. Any modifications, equivalent replacements, or improvements within the spirit and principles of the present invention should be included within the protection scope of the present invention.

We claim:

1. A nail driving assembly, comprising:
a nail head (61), a nail guide disk housing (62), a nail guide disk (63), a ratchet (64), a ratchet positioning mechanism (65), a push rod piston mechanism (66), and a nail guide tube (67),
wherein the nail guide disk (63) is rotatably disposed within the nail guide disk housing (62) via a second bearing (68), and a plurality of nail slots (631) for accommodating nails (16) are evenly arranged on the circumferential surface of the nail guide disk (63),
the ratchet (64) is fixedly connected to the nail guide disk (63) by bolts and rotates synchronously with the nail guide disk (63),
the ratchet positioning mechanism (65) is arranged on one side of the ratchet (64) to allow the ratchet (64) to rotate unidirectionally, and the push rod piston mechanism (66) is arranged on another side of the ratchet (64) to drive the ratchet (64) to rotate stepwise by a set angle,
the nail guide tube (67) is vertically fixed to the nail guide disk housing (62), the feed channel of the nail guide tube (67) corresponds to one of the nail slots (631) on the nail guide disk (63) to allow nails (16) to fall from the nail guide tube (67) into the nail slot (631),
the nail head (61) is fixed to the nail guide disk housing (62), a through-hole (611) is machined in a middle of the nail head (61), and a magnet (69) is arranged inside the nail head (61), the magnet (69) is located on one side of the through-hole (611) and uses magnetic force to attract the nail (16) in the adjacent nail slot (631) to the through-hole (611),
a reciprocating striker moves along the axial direction of the through-hole (611) to shoot the nail (16) out of the through-hole (611), completing the nailing action.

2. The nail driving assembly according to claim 1, wherein the ratchet positioning mechanism (65) comprises a positioning sleeve (651) fixed to the nail guide disk housing (62), a positioning pin (652) inside the positioning sleeve (651), and a first spring (653) supporting the positioning pin (652), the positioning pin (652) interacts with the ratchet teeth through an inclined surface on the left side, allowing the ratchet (64) to rotate only in the counterclockwise direction.

3. The nail driving assembly according to claim 2, wherein the push rod piston mechanism (66) comprises a solenoid valve (661), a cylinder (662), and a push rod assembly (663), the cylinder (662) is fixed to the nail guide disk housing (62), the cylinder shaft (6621) of the cylinder (662) is arranged along the tangential direction of the ratchet (64), the push rod assembly (663) is fixed to the shaft end of the cylinder (6621), the solenoid valve (661) is fixed to the nail guide disk housing (62), the solenoid valve (661) controls the reciprocating motion of the push rod assembly (663) by reversing the airflow direction in the cylinder (662).

4. The nail driving assembly according to claim 3, wherein the push rod assembly (663) comprises a push rod sleeve (6631) fixed to the cylinder shaft, a push rod (6632) inside the push rod sleeve (6631), and a second spring (6633) supporting the push rod (6632), the push rod (6632) interacts with the ratchet teeth through an inclined surface on the right side, driving the ratchet (64) to rotate stepwise by a set angle in the counterclockwise direction.

5. The nail driving assembly according to claim 4, wherein a first opening slot (621) is formed on the nail guide disk housing (62), and a second opening slot (612) is formed on the nail head (61), the first opening slot (621) communicates with the second opening slot (612) to facilitate the transfer of nails (16) from the nail slot (631) to the through-hole (611).

6. A loose nail driving device for wooden pallets, comprising:
a crossbeam (1), the lower part of the crossbeam (1) allowing semi-finished pallets to pass through, the crossbeam (1) is provided with multiple support slides (2), the support slides (2) can slide to achieve position adjustment in the transverse direction of the crossbeam (1);
a nailing unit (3), the nailing unit (3) is arranged on the support slides (2), the nailing unit (3) is used for nailing operations at various foot block positions of the semi-finished pallets;
the nailing unit (3) comprises a frame (5) and a nail driving assembly (6) arranged on the frame (5), the frame (5) is connected to the support slides (2) through a lifting cylinder (4), a rotatable large gear (7) and a driving mechanism (8) for driving the large gear (7) are configured on the base frame (51) of the frame (5), an eccentric hole (71) is machined on the disk surface of the large gear (7), the lower end of the nail head (61) of the nail driving assembly (6) is configured within the eccentric hole (71) through a first bearing (9);
to ensure the overall stability of the nail driving assembly (6), multiple universal wheel assemblies (10) are mounted on the nail driving assembly (6), the balls (101) at the bottom of the universal wheel assemblies (10) slide in contact with the upper surface of the large gear (7), a connecting rod frame (11) is fixed to the top of the nail driving assembly (6), a guide block (13) is fixed to the upper part of the side frame (52) of the frame (5), a rotatable connecting rod (12) is arranged on the connecting rod frame (11), the outer end of the connecting rod (12) extends into the guide hole (131) of the guide block (13).

7. The loose nail driving device for wooden pallets according to claim 6, wherein the large gear (7) forms a rotatable structure with the base frame (51) through a large bearing (14), multiple steel balls (15) distributed circumferentially are arranged between the large gear (7) and the base frame (51), forming a plane bearing structure between them.

8. The loose nail driving device for wooden pallets according to claim 7, wherein the driving mechanism (8) comprises a driving motor (81), a driving gear (82) arranged on the output end of the driving motor (81), and an intermediate gear (83) for transmitting the connection between the driving gear (82) and the large gear (7).
